(19) United States
(12) Patent Application Publication
(10) Pub. No.: US 2011/0129761 A1
(43) Pub. Date: Jun. 2, 2011

(54) FUEL MIXING TANK AND FUEL CELL SYSTEM

(75) Inventors: Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 12/850,646

(22) Filed: Aug. 5, 2010

(30) Foreign Application Priority Data
Nov. 27, 2009 (CN) 200910246383.X

(51) Int. Cl. H01M 8/04

(52) U.S. Cl. 429/513

(57) ABSTRACT

A fuel mixing tank adapted for supplying fuel to a fuel cell unit of a fuel cell system is provided. The fuel mixing tank includes a storage room, a supplying pipe, and a fuel recycling pipe. The storage room is adapted for communicating with the fuel cell unit to supply fuel to the fuel cell unit. The supplying pipe supplies fuel or water to the storage room and is thermally and adjacently connected to the storage room. The fuel recycling pipe is adapted for communicating with the fuel cell unit to recycle fuel from the fuel cell unit, and the fuel recycling pipe and the supplying pipe are connected at a convergence place communicating with the storage room. The fuel mixing tank has superior power generation efficiency.

### CROSS-REFERENCE TO RELATED APPLICATION

This application claims the priority benefit of China application serial no. 200910246383.X, filed on Nov. 27, 2009. The entirety of the above-mentioned patent application is hereby incorporated by reference herein and made a part of this specification.

### BACKGROUND OF THE INVENTION

1. Field of the Invention

The invention relates to a cell system, and particularly relates to a fuel mixing tank and a fuel cell system.

2. Description of Related Art

Fuel cells comply with the current trend for the advantages of high efficiency, low noise, and no pollution. The fuel cells may be categorized into several types, and the well-known fuel cells are proton exchange membrane fuel cells (PEMFC) and direct methanol fuel cells (DMFC). For instance, a fuel cell module of the PEMFC includes proton exchange membrane, cathode, and anode, and the cathode and the anode are disposed at two sides of the proton exchange membrane, respectively.

Performance of the fuel cell significantly relies on temperature. When the reaction temperature is low, the performance of the fuel cell is unfavorable. On the contrary, when the reaction temperature is high, the performance of the fuel cell may be improved. Patents regarding the fuel cells include Taiwan patents nos. M304116, M257015, I232004, I227575, U.S. patent application publications nos. 2006/0081130, and 2006/0286415, for example.

### SUMMARY OF INVENTION

The invention is directed to a fuel mixing tank and a fuel cell system having superior power generation efficiency.

Other features and advantages of the invention may be comprehended by the technical features broadly embodied and described herein.

An embodiment of the invention provides a fuel mixing tank adapted for supplying fuel to a fuel cell unit of a fuel cell system. The fuel mixing tank includes a storage room, a supplying pipe, and a fuel recycling pipe. The storage room is adapted for communicating with the fuel cell unit to supply fuel to the fuel cell unit. The supplying pipe supplies fuel or water to the storage room and is thermally and adjacently connected to the storage room. The fuel recycling pipe is adapted for communicating with the fuel cell unit to recycle fuel from the fuel cell unit, and the fuel recycling pipe and the supplying pipe are connected at a convergence place communicating with the storage room.

Another embodiment of the invention provides a fuel cell system including a fuel cell unit, a fuel supplying tank, a water supplying tank, and a fuel mixing tank. The fuel mixing tank includes a storage room, a supplying pipe, and a fuel recycling pipe. The storage room communicates with the fuel cell unit to supply fuel to the fuel cell unit. The supplying pipe communicates with the fuel supplying tank or the water supplying tank to supply fuel or water to the storage room. Besides, the supplying pipe is thermally and adjacently connected to the storage room. The fuel recycling pipe communicates with the fuel cell unit to recycle fuel from the fuel cell unit, and the fuel recycling pipe and the supplying pipe are connected at a convergence place communicating with the storage room.

Based on the above, the embodiments of the invention may have at least one of the following advantages. The fuel cell system heats up liquids (e.g. highly concentrated fuel and water) in the supplying pipe by the high-temperature fuel mixed in the storage room, so that the liquids and the recycled fuel in the supplying pipe are pre-heated before the liquids and the recycled fuel are mixed, thus stabilizing the temperature of the fuel mixed in the storage room and further improving the power generation efficiency of the fuel cell system. In addition, the storage room may communicate with the water supplying tank, such that a water level of the storage room does not change drastically, and that fuel concentration within the storage room may be precisely controlled. Moreover, the water supplying tank may be further equipped with a water gauge to measure a water level of the water supplying tank, so as to compensate for water deficiency in the water supplying tank.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a fuel cell system according to an embodiment of the invention.

FIG. 2 is a schematic view illustrating a fuel mixing tank depicted in FIG. 1.

FIG. 3 is a cross-sectional view illustrating the fuel mixing tank depicted in FIG. 2 and taken along a sectional line A-A.

FIG. 4 is a cross-sectional view illustrating the fuel mixing tank depicted in FIG. 2 and taken along a sectional line B-B.

FIG. 5 illustrates communication between the fuel mixing tank depicted in FIG. 2 and a water supplying tank.

FIG. 6 is a block diagram illustrating a fuel cell system according to another embodiment of the invention.

FIG. 7 is a block diagram illustrating a fuel cell system according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

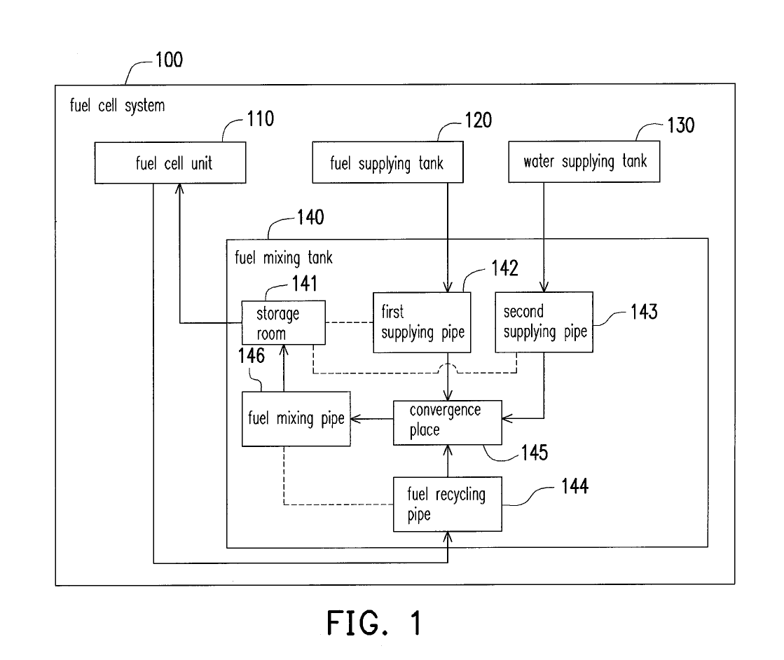

As shown in FIG. 1, a fuel cell system 100 includes a fuel cell unit 110, a fuel supplying tank 120, a water supplying tank 130, and a fuel mixing tank 140. The fuel cell unit 110 is capable of performing chemical reactions, and the fuel mixing tank 140 is capable of mixing and storing fuel. In this embodiment, the fuel refers to a methanol (CH₃OH) solution, for example.

In this embodiment, the fuel mixing tank 140 includes a storage room 141, a first supplying pipe 142, a second supplying pipe 143, and a fuel recycling pipe 144. The storage room 141 communicates with the fuel cell unit 110 to supply fuel with proper concentration to the fuel cell unit 110. The first supplying pipe 142 communicates with the fuel supplying tank 120 to supply highly concentrated fuel to the storage room 141. Besides, the first supplying pipe 142 is thermally and adjacently connected to the storage room 141. The second supplying pipe 143 communicates with the water supplying tank 130 to supply water to the storage room 141. Besides, the second supplying pipe 143 is thermally and adjacently connected to the storage room 141. The fuel recycling pipe 144 communicates with the fuel cell unit 110 to recycle fuel with low concentration from the fuel cell unit 110, and the fuel recycling pipe 144, the first supplying pipe 142, and the second supplying pipe 143 are connected at a convergence place 145 communicating with the storage room 141.

When the fuel cell unit 110 reacts, the high-temperature fuel recycled by the fuel recycling pipe 144 flows to the storage room 141 through the convergence place 145. Thus, the first supplying pipe 142 and the second supplying pipe 143 which are both thermally and adjacently connected to the storage room 141 may be heated up by high-temperature fuel within the storage room 141, and both the fuel temperature within the first supplying pipe 142 and the water temperature within the second supplying pipe 143 are increased accordingly. The high-temperature fuel mixed in the storage room 141 may be used to heat up the highly concentrated fuel in the first supplying pipe 142 and the water in the second supplying pipe 143, such that the highly concentrated fuel, the water and the recycled fuel are pre-heated before the highly concentrated fuel, the water and the recycled fuel are mixed. Thereby, the fuel mixed in the storage room 141 may have stable temperature, and the power generation efficiency of the fuel cell system 100 is further improved.

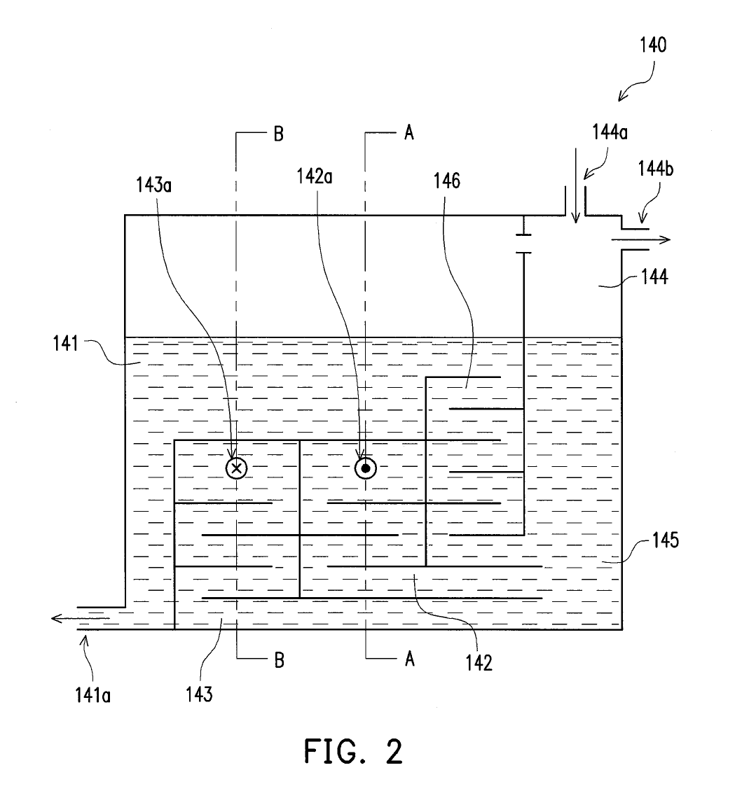

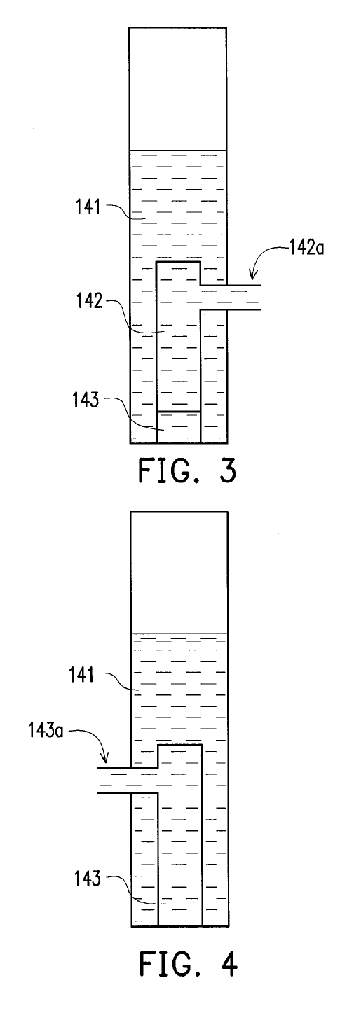

Referring to FIG. 1 to FIG. 4, according to the embodiment, the fuel mixing tank 140 further includes a fuel mixing pipe 146 communicating with the storage room 141. The fuel mixing pipe 146 is thermally and adjacently connected to the fuel recycling pipe 144 to receive the resulting heat from the high-temperature fuel in the fuel recycling pipe 144. Moreover, the water and the fuel in the fuel mixing pipe 146 are heated up. In addition, the fuel mixing pipe 146 may be curvedly extended, so as to increase thermal contact between the liquid in the fuel mixing pipe 146 and the liquid in the fuel recycling pipe 144 and improve the uniform mixing effect of the fuel.

Similarly, the first supplying pipe 142 and the second supplying pipe 143 may be also curvedly extended to increase the thermal contact with the fuel mixing pipe 146 and the storage room 141, respectively. In addition, the first supplying pipe 142 may have a first supplying port 142a, and the second supplying pipe 143 may have a second supplying port 143a. The first supplying pipe 142 communicates with the fuel supplying tank 120 through the first supplying port 142a to supply fuel to the storage room 141. On the other hand, the second supplying pipe 143 communicates with the water supplying tank 130 through the second supplying port 143a to supply water to the storage room 141.

In this embodiment, the storage room 141 may have an output port 141a and communicate with the fuel cell unit 110 through the output port 141a. In addition, the fuel recycling pipe 144 may have a recycling port 144a and communicate with the fuel cell unit 110 through the recycling port 144a.

Additionally, the fuel recycling pipe 144 may further have an exhaust port 144b directly communicating with the storage room 141 in a ventilating manner, so as to release reaction gas (e.g. CO₂ or water vapor) from the fuel cell unit 110. In another embodiment, the storage room may also have an exhaust port directly communicating with the fuel recycling pipe in a ventilating manner. Besides, according to another embodiment, the water supplying tank may also have an exhaust port directly communicating with the storage room in a ventilating manner.

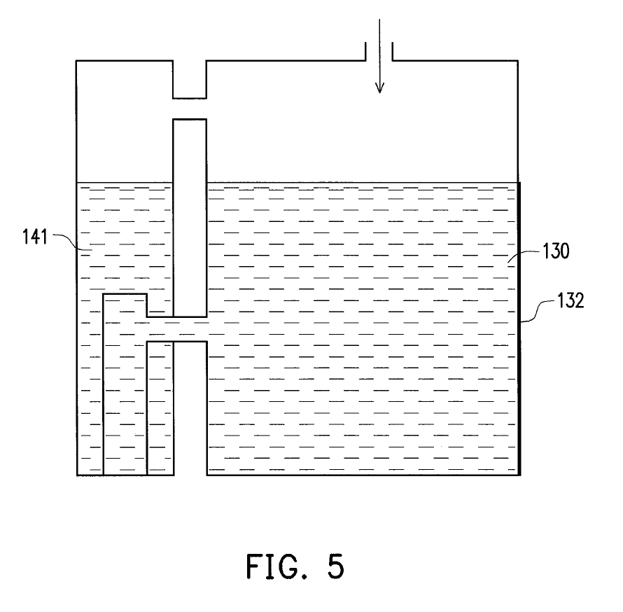

Referring to FIG. 1 to FIG. 5, the storage room 141 and the water supplying tank 130 communicate with each other according to the embodiment, and based on the principle of communicating tubes, a water level in the storage room 141 is equal to a water level in the water supplying tank 130. Therefore, based on the principle of communicating tubes, water in the water supplying tank 130 automatically flows to the storage room 141, and it is not necessary to additionally install other pump devices. Moreover, in order to compensate for water deficiency in the water supplying tank 130, the water supplying tank 130 may be further equipped with a water gauge 132 to measure the water level of the water supplying tank 130.

The volume of the storage room 141 may be smaller than the volume of the water supplying tank 130 in the embodiment. So that, the water level of the storage room 141 may not change drastically, and the fuel concentration within the storage room 141 may be precisely controlled. In addition, temperature loss in the storage room 141 is rather unlikely, so as to keep or increase temperature of fuel in the storage room 141 and to further improve power generation efficiency of the fuel cell system 100.

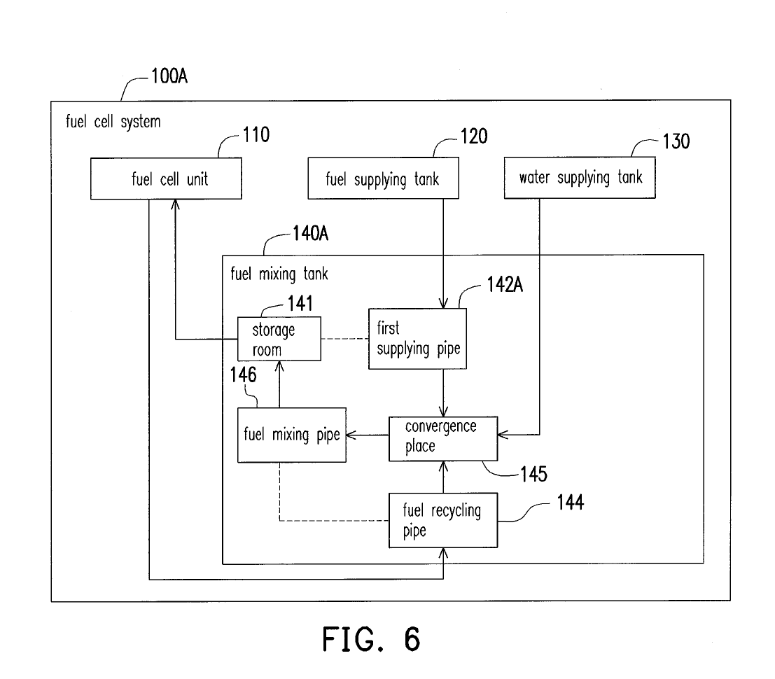

In comparison with the embodiment illustrated in FIG. 1, the embodiment depicted in FIG. 6 provides a fuel mixing tank 140A of a fuel cell system 100A. The fuel mixing tank 140A has a first supplying pipe 142A communicating with the fuel supplying tank 120 to supply fuel to the storage room 141. Besides, the water supplying tank 130 may be directly connected to the convergence place 145.

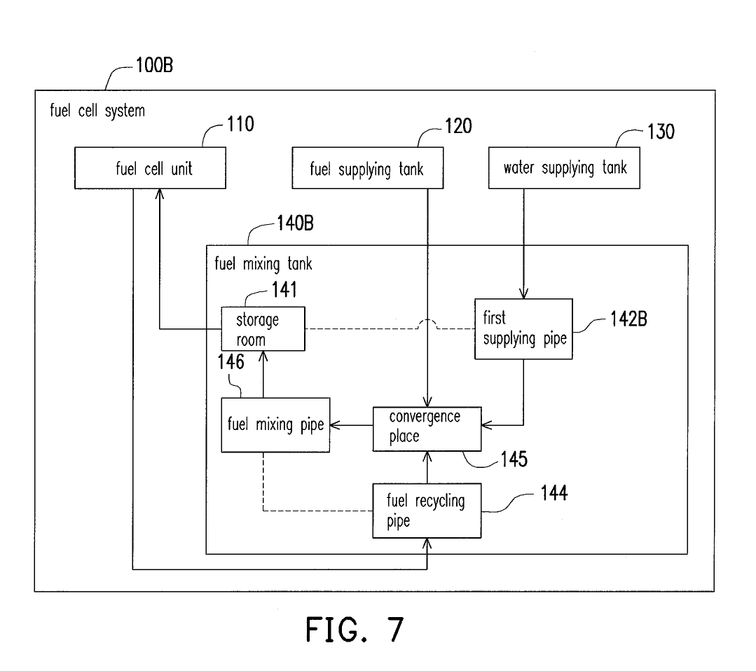

In comparison with the embodiment illustrated in FIG. 1, the embodiment depicted in FIG. 7 provides a fuel mixing tank 140B of a fuel cell system 100B. The fuel mixing tank 140B has a first supplying pipe 142B communicating with the water supplying tank 130 to supply water to the storage room 141. Besides, the fuel supplying tank 120 may be directly connected to the convergence place 145.

In summary, the embodiments of the invention may have at least one of the following advantages. The fuel cell system heats up liquids (e.g. highly concentrated fuel and water) in the supplying pipe by the high-temperature fuel mixed in the storage room, so that the liquids and the recycled fuel in the supplying pipe are pre-heated before the liquids and the recycled fuel are mixed, thus stabilizing the temperature of the fuel mixed in the storage room and further improving the power generation efficiency of the fuel cell system. In addition, the storage room communicates with the water supplying tank, so that the water level of the storage room may not change drastically, and the fuel concentration within the storage room may be precisely controlled. Moreover, the water supplying tank may be further have the water gauge to measure the water level of the water supplying tank and to compensate for water deficiency of the water supplying tank.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel mixing tank, adapted for supplying fuel to a fuel cell unit of a fuel cell system, the fuel mixing tank comprising:
a storage room, adapted for communicating with the fuel cell unit to supply fuel to the fuel cell unit;
a first supplying pipe, for supplying fuel or water to the storage room, the first supplying pipe being thermally and adjacently connected to the storage room; and
a fuel recycling pipe, adapted for communicating with the fuel cell unit to recycle fuel from the fuel cell unit, wherein the fuel recycling pipe and the first supplying pipe are connected at a convergence place communicating with the storage room.

2. The fuel mixing tank of claim 1, further comprising:
a fuel mixing pipe, communicating with the storage room, wherein the fuel recycling pipe and the first supplying pipe are connected at the convergence place communicating with the fuel mixing pipe.

3. The fuel mixing tank of claim 2, wherein the fuel mixing pipe extends curvingly.

4. The fuel mixing tank of claim 2, wherein the fuel mixing pipe is thermally and adjacently connected to the fuel recycling pipe.

5. The fuel mixing tank of claim 1, wherein the first supplying pipe has a first supplying port, and the first supplying pipe communicates with a fuel supplying tank or a water supplying tank of the fuel cell system through the first supplying port.

6. The fuel mixing tank of claim 5, wherein the first supplying pipe extends curvingly.

7. The fuel mixing tank of claim 1, further comprising:
a second supplying pipe, the first supplying pipe and the second supplying pipe respectively supplying fuel and water to the storage room and being thermally and adjacently connected to the storage room, wherein the second supplying pipe, the first supplying pipe, and the fuel recycling pipe are connected at the convergence place communicating with the storage room.

8. The fuel mixing tank of claim 7, further comprising:
a fuel mixing pipe, communicating with the storage room, wherein the fuel recycling pipe, the first supplying pipe, and the second supplying pipe are connected at the convergence place communicating with the fuel mixing pipe.

9. The fuel mixing tank of claim 7, wherein the first supplying pipe has a first supplying port, the second supplying pipe has a second supplying port, and the first supplying pipe and the second supplying pipe communicate with a fuel supplying tank and a water supplying tank of the fuel cell system through the first supplying port and the second supplying port, respectively.

10. The fuel mixing tank of claim 7, wherein the second supplying pipe extends curvingly.

11. The fuel mixing tank of claim 1, wherein the storage room has an output port, and the storage room is adapted for communicating with the fuel cell unit through the output port.

12. The fuel mixing tank of claim 1, wherein the fuel recycling pipe has a recycling port, and the fuel recycling pipe is adapted for communicating with the fuel cell unit through the recycling port.

13. The fuel mixing tank of claim 1, wherein the fuel recycling pipe further has an exhaust port directly communicating with the storage room in a ventilating manner.

14. The fuel mixing tank of claim 1, wherein the storage room further has an exhaust port directly communicating with the fuel recycling pipe in a ventilating manner.

15. A fuel cell system, comprising:
a fuel cell unit;
a fuel supplying tank;
a water supplying tank; and
a fuel mixing tank, comprising:
a storage room, communicating with the fuel cell unit to supply fuel to the fuel cell unit;
a first supplying pipe, communicating with the fuel supplying tank or the water supplying tank to supply fuel or water to the storage room, the first supplying pipe being thermally and adjacently connected to the storage room; and
a fuel recycling pipe, communicating with the fuel cell unit to recycle fuel from the fuel cell unit, wherein the fuel recycling pipe and the first supplying pipe are connected at a convergence place communicating with the storage room.

16. The fuel cell system of claim 15, wherein the fuel mixing tank further comprises:
a fuel mixing pipe, communicating with the storage room, wherein the fuel recycling pipe and the first supplying pipe are connected at the convergence place communicating with the fuel mixing pipe.

17. The fuel cell system of claim 16, wherein the fuel mixing pipe extends curvingly.

18. The fuel cell system of claim 16, wherein the fuel mixing pipe is thermally and adjacently connected to the fuel recycling pipe.

19. The fuel cell system of claim 15, wherein the first supplying pipe has a first supplying port, and the first supplying pipe communicates with the fuel supplying tank or the water supplying tank through the first supplying port.

20. The fuel cell system of claim 15, wherein the first supplying pipe extends curvingly.

21. The fuel cell system of claim 15, wherein the fuel mixing tank further comprises:
a second supplying pipe, the first supplying pipe and the second supplying pipe respectively supplying fuel and water to the storage room and being thermally and adjacently connected to the storage room, wherein the second supplying pipe, the first supplying pipe, and the fuel recycling pipe are connected at the convergence place communicating with the storage room.

22. The fuel cell system of claim 21, wherein the fuel mixing tank further comprises:
a fuel mixing pipe, communicating with the storage room, wherein the fuel recycling pipe, the first supplying pipe, and the second supplying pipe are connected at the convergence place communicating with the fuel mixing pipe.

23. The fuel cell system of claim 21, wherein the second supplying pipe extends curvingly.

24. The fuel cell system of claim 21, wherein the first supplying pipe has a first supplying port, the second supplying pipe has a second supplying port, and the first supplying pipe and the second supplying pipe communicate with the fuel supplying tank and the water supplying tank through the first supplying port and the second supplying port, respectively.

25. The fuel cell system of claim 15, wherein the storage room has an output port, and the storage room communicates with the fuel cell unit through the output port.

26. The fuel cell system of claim 15, wherein the fuel recycling pipe has a recycling port, and the fuel recycling pipe communicates with the fuel cell unit through the recycling port.

27. The fuel cell system of claim 15, wherein the fuel recycling pipe further has an exhaust port directly communicating with the storage room in a ventilating manner.

28. The fuel cell system of claim 15, wherein the storage room further has an exhaust port directly communicating with the fuel recycling pipe in a ventilating manner.

29. The fuel cell system of claim 15, wherein the water supplying tank has an exhaust port directly communicating with the storage room in a ventilating manner.

30. The fuel cell system of claim 15, wherein a volume of the storage room is smaller than a volume of the water supplying tank, a water level of the storage room is equal to a water level of the water supplying tank, and the water supplying tank further has a water gauge to measure the water level of the water supplying tank.
